(19) United States
(12) Patent Application Publication
(10) Pub. No.: US 2026/0320463 A1
(43) Pub. Date: Oct. 15, 2026

(54) QUANTUM COMPUTATION METHOD

(71) Applicants: KEIO UNIVERSITY, Tokyo (JP); MIZUHO RESEARCH & TECHNOLOGIES, LTD., Tokyo (JP); Mizuho Financial Group, Inc., Tokyo (JP)

(72) Inventors: Kohei OSHIO, Tokyo (JP); Naoki YAMAMOTO, Tokyo (JP); Kaito WADA, Tokyo (JP)

(21) Appl. No.: 19/542,102

(22) Filed: Feb. 17, 2026

(30) Foreign Application Priority Data
Apr. 14, 2025 (JP) 2025-066233

(51) Int. Cl. G06N 10/60; G06N 10/20; G06N 10/40

(52) U.S. Cl. CPC G06N 10/60; G06N 10/20; G06N 10/40

(57) ABSTRACT

A quantum computing system includes processors and memory storing executable instructions that, when executed by the processors, cause the quantum computing system to modulate, by an operation unit of a quantum computation unit, a quantum state, maintain, by a state holding unit of the quantum computation unit, the quantum state, observe, by a measurement unit of the quantum computation unit, the quantum state, obtain a first operator for use in performing an operation of embedding a parameter into an amplitude of the quantum state, form a second operator, using the first operator, apply multiple instances of the second operator in parallel to an entangled input state, measure the quantum state after applying the second operator to produce a measurement result to estimate a value of the phase, and estimate, at a classical computation unit, the parameter based on the value of the phase.

### CROSS-REFERENCE TO RELATED APPLICATIONS

This application is based upon and claims the benefit of priority from Japanese Patent Application No. 2025-066233, filed on Apr. 14, 2025, the entire contents of which are incorporated herein by reference.

### BACKGROUND

### 1. Field

The present disclosure relates to a quantum computation method for estimating the amplitude of a quantum state.

### 2. Description of Related Art

Quantum amplitude estimation (QAE) is a basic algorithm used in many quantum algorithms. Quantum amplitude estimation is key to acceleration of many applications including financial simulations using quantum computers. For example, JP2025-008164 discusses a technique for providing an amplitude estimation method for efficiently executing amplitude estimation.

In quantum amplitude estimation, a first operator Uₚᵣ, which embeds a desired value into an amplitude, is provided as a gate operation. The first operator Uₚᵣ is used to estimate the value α of the amplitude. The first operator Uₚᵣ is expressed by the following equation.

Uₚᵣ|0 [symbol] ^{⊗n+1}=cos θ|Ψ₀ [symbol] |0 [symbol] +sin θ|Ψ₁ [symbol] |1 [symbol] ,α≡sin²θ∈[0,1]
   |Ψ₁ [symbol] , |Ψ₀: quantum states of n qubits

The performance of quantum amplitude estimation is evaluated in terms of the relationship (query complexity) between the number N of invocations of the first operator Uₚᵣ and the estimation error F of the amplitude. By employing amplitude amplification using a Grover operator Q formed from the first operator Uₚᵣ, the query complexity is set to N=O(1/ε), corresponding to Heisenberg scaling. O denotes the Landau symbol, which represents the order of growth of the computational complexity of the algorithm.

In conventional quantum amplitude estimation, it is necessary to execute a quantum circuit in which the number of quantum gates arranged in a series direction (depth) is O(1/ε) with respect to the estimation error ε.

If the scaling of the depth of the quantum circuit, which is executed in the quantum amplitude estimation, with respect to ε, is improved, it becomes possible to achieve more efficient utilization of computational resources, reduced computation time, and reduction in the required coherence time. Tudor Giurgica-Tiron et al. have proposed techniques for improving the scaling of the depth of a quantum circuit with respect to ε in quantum amplitude estimation (“Low depth algorithms for quantum amplitude estimation,” Nov. 6, 2020, https://arxiv.org/abs/2012.03348).

Methods for estimating parameters embedded in quantum systems, such as quantum amplitude estimation, can also be considered from the perspective of quantum metrology. JP2025-008164A describes attempts to optimize quantum amplitude estimation and expectation value estimation algorithms based on the theory of quantum metrology. In quantum metrology, estimation accuracy may be improved by entangling input states and then applying quantum channels that embed parameters into the phase of the quantum states in parallel with the input states (a parallel strategy). Shelby Kimmel et al. have shown that a technique called robust phase estimation can be used as an algorithm for estimating parameters embedded in the phases of quantum states (phase estimation) using a parallel strategy (“Robust Calibration of a Universal Single-Qubit Gate-Set via Robust Phase Estimation,” Feb. 9, 2015, https://arxiv.org/abs/1502.02677).

G. H. Low et al. have proposed quantum signal processing (QSP) as a technique in quantum computation for forming, with respect to an operator given as a gate operation, another operator whose eigenvalues are polynomial transformed (“Optimal Hamiltonian Simulation by Quantum Signal Processing,” Jan. 8, 2016, https://arxiv.org/abs/1606.02685). In quantum signal processing, the transformation operation is controlled by certain parameters, which need to be determined in order to achieve the desired transformation. Rui Chao et al. have examined techniques for computing this parameter (“Finding Angles for Quantum Signal Processing with Machine Precision,” Mar. 17, 2020). Their algorithm employs two techniques, referred to as “halving” and “capitalization.” By applying these techniques, the parameter may be computed more stably than was previously possible.

### SUMMARY

It is an objective of the present disclosure to provide a quantum computation method capable of efficiently estimating a parameter embedded in the amplitude of a quantum state.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In conventional quantum amplitude estimation, in order to improve estimation accuracy while maintaining Heisenberg scaling, the depth of a quantum circuit must scale as O(1/ε) with respect to the estimation error ε. Tudor Giurgica-Tiron et al. have presented a method for improving the scaling of the depth. However, in that method the query complexity worsens depending on the degree of improvement in the depth scaling, approaching N=O(1/ε²). In quantum amplitude estimation, no algorithm has yet been realized that significantly improves the scaling of depth while maintaining query complexity with only minimal overhead.

In a first embodiment, a quantum computing system includes a quantum computation unit and a classical computation unit. The quantum computation unit includes an operation unit that operates a quantum state, a state holding unit that holds the quantum state, and a measurement unit that observes the quantum state. The operation unit is configured to obtain a first operator for performing an operation of embedding a parameter into an amplitude of a quantum state, and form a second operator for performing an operation of embedding the parameter in a phase of a quantum state by using the first operator. The measurement unit is configured to apply, in parallel, the second operator to an entangled input state to measure a quantum state after applying the second operator to the entangled input state, and estimate a phase based on a measurement result. The classical computation unit is configured to estimate the parameter by using an estimation result of the phase.

In a second embodiment, a quantum computing method includes obtaining a first operator for performing an operation of embedding a parameter into an amplitude of a quantum state, forming a second operator for performing an operation of embedding the parameter in a phase of a quantum state by using the first operator, applying, in parallel, the second operator to an entangled input state to measure a quantum state after applying the second operator to the entangled input state, estimating a phase based on a measurement result, and estimating the parameter by using an estimation result of the phase.

In a third embodiment, a non-transitory computer-readable medium storing instructions is provided. When executed by processors, the instructions cause the processors to perform a method including operations that include obtaining a first operator for performing an operation of embedding a parameter into an amplitude of a quantum state, forming a second operator for performing an operation of embedding the parameter in a phase of a quantum state by using the first operator, applying, in parallel, the second operator to an entangled input state to measure a quantum state after applying the second operator to the entangled input state, estimating a phase based on a measurement result, and estimating the parameter by using an estimation result of the phase.

Other features and aspects will be apparent from the following detailed description, the drawings, and the claims.

### BRIEF DESCRIPTION OF THE DRAWINGS

FIG. 1 is a schematic diagram of a system according to an embodiment.

FIG. 2 is an explanatory diagram illustrating a hardware configuration according to the embodiment.

FIG. 3 is an explanatory diagram illustrating an overview of a procedure of processes according to the embodiment.

FIG. 4 is an explanatory diagram illustrating a quantum circuit according to the embodiment.

FIG. 5 is an explanatory diagram illustrating the quantum circuit according to the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

It is recognized herein that quantum computing systems implementing quantum amplitude estimation by parallel and series applications of operators on entangled qubits would be advantageous. The techniques disclosed herein provide a quantum computing system including a quantum computation unit in combination with a classical processing unit to enable manipulation of the quantum states of qubits using specifically generated operators applied in both parallel and serial manners to the entangled input state of the qubits to improve the quantum amplitude estimation results.

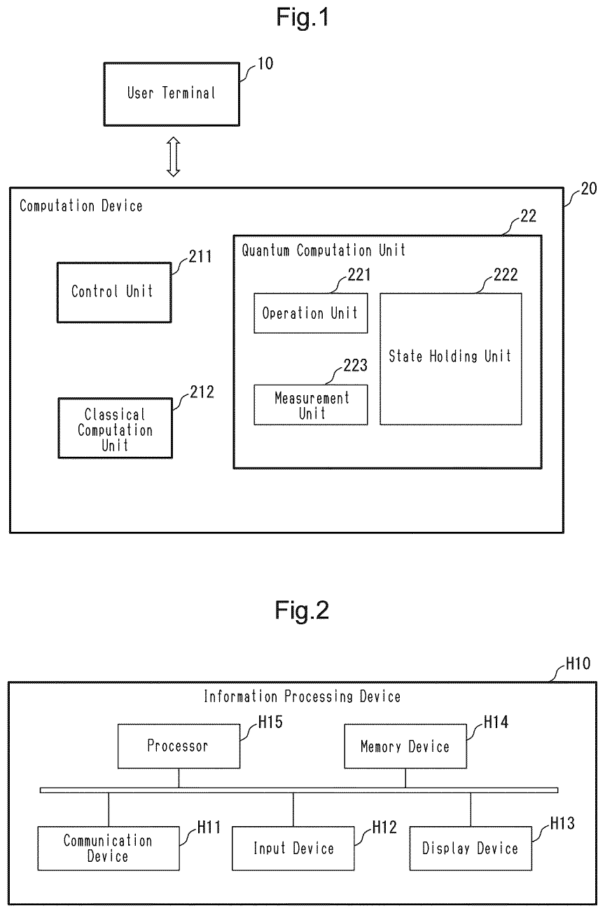

A quantum computing method according to embodiments will now be described with reference to FIGS. 1 to 5. In embodiments, a first operator performs an operation that embeds a parameter into the amplitude of a quantum state. A second operator is formed from the first operator and performs an operation that embeds the parameter into the phase of the quantum state. The quantum states are measured by arranging multiple second operators in both parallel and serial configurations. Based on the measurement results, the phase is estimated. The parameter is then estimated using the estimated phase. In this embodiment, the first operator is converted into the second operator, which is compatible with a parallel strategy, and phase estimation is performed using the parallel strategy.

### Description of Hardware Configuration

The hardware configuration of an information processing device H10 forming a user terminal 10 and a computation device 20 (a control unit 211 and a classical computation unit 212) will be described with reference to FIG. 2. The information processing device H10 includes a communication device H11, an input device H12, a display device H13, a memory device H14, and a processor H15. This hardware configuration is merely one example, and the user terminal 10 and the arithmetic device 20 may be implemented by other hardware.

The communication device H11 is an interface (for example, a network interface or a wireless interface) that establishes communication paths with other devices to transmit and receive data.

The input device H12 is a device (for example, a mouse or a keyboard) that receives input from a user. The display device H13 is a device (for example, a display) that displays various types of information.

The memory device H14 stores data and various programs used to implement various functions of the user terminal 10 and the computation device 20. Examples of the memory device H14 include ROM, RAM, and a hard disk drive.

The processor H15 uses programs and data stored in the memory device H14 to control processes at the user terminal 10 and the computation device 20. Examples of the processor H15 include a CPU and an MPU. The processor H15 executes various processes for each service by deploying programs stored in the ROM or the like into the RAM.

The processor H15 is not limited to execution of all processes through software processing. For example, the processor H15 may include a dedicated hardware circuit (e.g., application specific integrated circuit) configured to perform hardware processing on some of the processes executed thereby. That is, the processor H15 may be composed of circuitry including the following:
(1) One or more processors that operate according to a computer program.
(2) One or more dedicated hardware circuitry that executes at least part of various processes.
(3) A combination thereof.

The processor includes a CPU and memory such as RAM and ROM. The memory stores program codes or instructions configured to cause the CPU to execute processes. The memory, namely, a computer-readable medium, includes any available medium that is accessible by a general-purpose or special-purpose computer.

### System Configuration of Computation Device 20

Next, a system configuration of the user terminal 10 and the computation device 20, which are connected with each other, will be described with reference to FIG. 1.

The user terminal 10 is a computer terminal used by a user.

The computation device 20 is a computer for performing quantum amplitude estimation.

The computation device 20 executes processes discussed below (such as processes at a management stage, a classical computation stage, and a quantum computation stage and others). By executing programs for these processes, the computation device 20 functions as the control unit 211, the classical computation unit 212, and a quantum computation unit 22.

The control unit 211 manages quantum computation and classical computation.

The classical computation unit 212 performs a statistical process for maximum likelihood estimation using classical computation.

The quantum computation unit 22 performs quantum computation. The quantum computation unit 22 includes an operation unit 221, a state holding unit 222, and a measurement unit 223.

The operation unit 221 performs a quantum operation on qubits of the state holding unit 222 according to a program. In this case, the operation unit 221 operates (creates) the state held by the state holding unit 222 by using a quantum circuit including quantum gates or the like.

The state holding unit 222 includes multiple qubits and holds any desired quantum state. Each qubit holds a superposition of multiple values in any desired physical state such as an electron level, an electron spin, an ion level, a nuclear spin, or a photon. The qubit is not limited to the above if the superposition state can be maintained.

The measurement unit 223 observes the eigenstate of the superposition state of the qubits of the state holding unit 222. The measurement unit 223 records the number of hits according to the observed states of the qubits in the state holding unit 222. The measurement unit 223 outputs the observed values to the classical computation unit 212 via the control unit 211.

### Overview of Quantum Computation

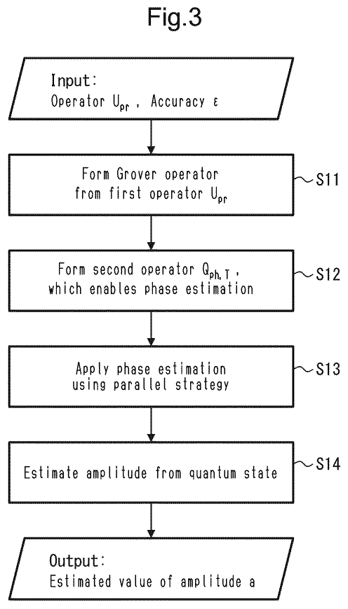

Next, an overview of quantum computation will be described with reference to FIG. 3.

First, the computation device 20 forms a Grover operator from the first operator Uₚᵣ(step S11). In this example, the following first operator Uₚᵣ is acquired from the user terminal 10 in order to perform an operation of embedding a parameter α in the amplitude of a quantum state.

Uₚᵣ:Uₚᵣ|0 [symbol] ^{⊗n+1}=cos θ|Ψ₀ [symbol] |0+sin θ|Ψ₁ [symbol] |1 [symbol] ,α≡sin²θ∈[0,1]
   |0 [symbol] ^{⊗n+1}: initial state

When the first operator Uₚᵣ is applied to an initial state, a superposition state of |Ψ₀ [symbol] |0 [symbol] and |Ψ₁ [symbol] |1 [symbol] is obtained.

For the first operator Uₚᵣ, the following Grover operator Q is formed.

$$Q = {U}_{0} {U}_{pr}^{†} {U}_{f} {U}_{pr}$$

Specifically, the operators U_{f} and U₀ are expressed as follows. I denotes the identity operator.

U_{f}=2I^{⊗n}⊗|0 [symbol] 0|−I^{⊗n+1}

U₀=2|0 [symbol] ^{⊗n+1} [symbol] 0|^{⊗n+1}−I^{⊗n+1}

Next, the computation device 20 uses a controlled Grover operator CQ, obtained by controlling Grover operator Q using an auxiliary qubit, to form a second operator Q_{ph,T}, which enables phase estimation using the parallel strategy (step S12). The second operator Q_{ph,T} is an operator that embeds a value dependent on T·α into the phase of a quantum state, where T is a parameter representing the signal amplification strength included in the second operator Q_{ph,T}.

The controlled Grover operator CQ is expressed as follows.

CQ|0 [symbol] |Q_{±} [symbol] =|0 [symbol] |Q_{±} [symbol] ,CQ|1 [symbol] |Q_{±} [symbol] ±e^{±2iθ}|1 [symbol] |Q_{±} [symbol]
   |Q_{±}): Eigenstate of Q that satisfies Q|Q_{±} [symbol] =e^{±2iθ}|Q_{±}

[symbol]

In this example, the second operator Q_{ph,T} can be formed by quantum signal processing proposed by G. H. Low et al. as described below. Rₓ and R_{z} denote rotation operators with respect to the X-axis and Z-axis of the Bloch sphere, respectively. H_{⊥} denotes a subspace of an (n+2)-qubit Hilbert space spanned by quantum states orthogonal to |0 [symbol] ₙ₊₂ and |1 [symbol] ₙ₊₂. L denotes the number of repetitions of a unit process in quantum signal processing. The basis of the matrix is |0 [symbol] and |1 [symbol] , and e^{iφu} denotes an eigenvalue corresponding to |u [symbol] . When the second operator Q_{ph,T} is formed using quantum signal processing, the signal amplification strength T can be adjusted by varying the duration of the time evolution in the quantum signal processing.

$${{{Q}_{ph , T} = {\prod }_{l = 1}^{L} {R}_{X} ( - {ξ}_{l} ) \cdot {R}_{Z} ( π / 2 ) \cdot CQ \cdot {R}_{X} ( {ξ}_{l} ) \approx ( \begin{matrix}{e}^{- iTcos 2 θ} & 0 \\ 0 & {e}^{iTcos 2 θ}\end{matrix} ) ⊗ \vert 0 〉}^{⊗ n + 1} 〈 0 \vert}^{⊗ n + 1} + {\sum }_{\vert u 〉 ∈ {ℋ}_{⊥}} {e}^{i {ϕ}_{u}} \vert u 〉 〈 u \vert$$

$${{{{\vert 0 〉}_{n + 2} : \vert 0 〉 \vert 0 〉}^{⊗ n + 1} , \vert 1 〉}_{n + 2} : \vert 1 〉 \vert 0 〉}^{⊗ n + 1}$$

Given a “Only the first bit is |1 [symbol] , and all other n+1 bits are |0 [symbol] ” quantum state, the second operator Q_{ph,T} is an operator that approximately imparts Tφₐ=2T cos 2θ, that is, a “2T(1−2a)” phase to a quantum state. The rotation angles ζ₁, ζ₂, . . . , ζ_{L} are phase parameters in quantum signal processing and are determined, for example, by calculations performed on a conventional computer in accordance with the method proposed by Rui Chao et al., in order to implement a desired transformation.

Next, after forming the second operator Q_{ph,T}, the computation device 20 performs phase estimation by applying the parallel strategy (step S13). Through this process, the value φₐ embedded in the phase by the second operator Q_{ph,T} is estimated.

First, the following quantum state is prepared as the input state.

|GHZ_{P} [symbol] |0 [symbol] ^{⊗(n+1)P}

P denotes the number of qubits to be entangled, and |GHZ_{P} [symbol] denotes the Greenberger-Horne-Zeilinger (GHZ) state of the following equation.

$$\vert {GHZ}_{P} 〉 = \frac{{{\vert 0 〉}^{⊗ P} + \vert 1 〉}^{⊗ P}}{\sqrt{2}}$$

The second operator Q_{ph,T}(520) is applied to the input state in a configuration having a series count S and a parallel count P, so that a value M_{φ}_{_{α}}, obtained by amplifying φ_{α} by M(=P·S·T), can be approximately embedded into the phase of the quantum state.

$${{{{{( {Q}_{ph , T}^{s} )}^{⊗ P} ( \vert {GHZ}_{P} 〉 \vert 0 〉}^{⊗ ( n + 1 ) P} ) \approx \frac{1}{\sqrt{2}} ( \vert 0 〉}^{⊗ P} + {e}^{i \cdot {M}_{{ϕ}_{a}}} \vert 0 〉}^{⊗ P} ) \vert 0 〉}^{⊗ ( n + 1 ) P}$$

Next, by performing phase estimation using the parallel strategy, an approximate value of φ_{α} embedded into the phase of the quantum state by the second operator Q_{ph,T} is estimated. In the phase estimation using the parallel strategy, the operators are arranged in both series and parallel directions as described above so that M_{φ}_{_{α}} is approximately embedded into the phase of the quantum state, and measurement is repeatedly performed in an appropriate measurement basis while varying M. Thereafter, an approximate value of φ_{α} is estimated using all measurement results obtained for each M. The maximum value of M is determined in accordance with the required estimation error F, and the number of measurements for each M is set to be sufficiently large to allow the estimation to be reliably performed. As a method of such phase estimation, for example, the robust phase estimation proposed by Shelby Kimmel et al. may be employed. When M is varied, it may be necessary to change the signal amplification strength T included in the second operator Q_{ph,T}, in which case the second operator Q_{ph,T} must be formed again according to the above-described procedure.

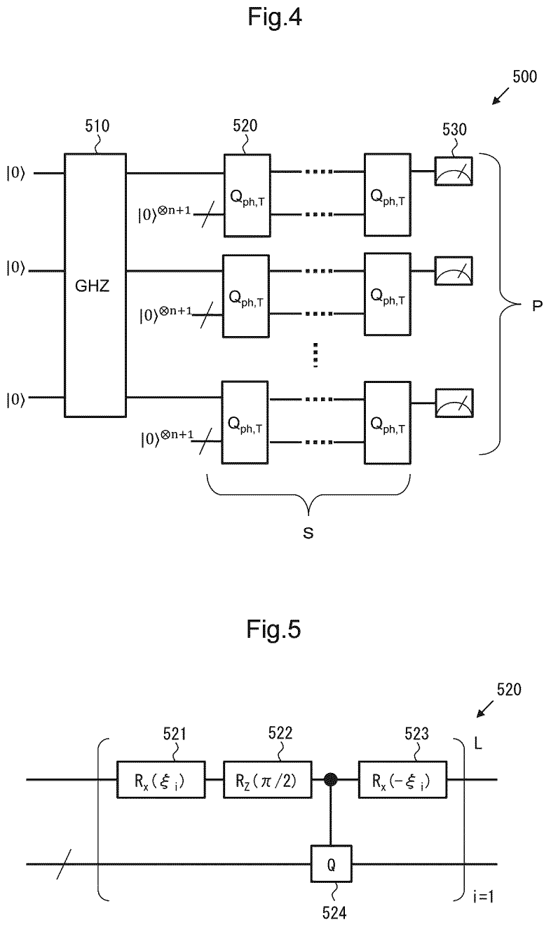

FIG. 4 shows a quantum circuit 500 for performing this computation.

The quantum circuit 500 includes an entangling operator 510, multiple instances of the second operator Q_{ph,T}(520), and multiple instances of a measurement process 530.

The entangling operator 510 is an operator for generating the above-described |GHZ_{P}).

In the quantum circuit 500, the second operator Q_{ph,T} are arranged in series S times and in parallel P times (i.e., P is defined as the parallel count, for the number of times the second operator is applied in parallel at the quantum circuit; S is defined as the series count, for the number of times the second operator is applied in series). The series count S of the second operator Q_{ph,T} and the signal amplification strength T included in the second operator Q_{ph,T} are subject to upper limits determined by the coherence time Tc, which is the maximum duration for which the quantum state can be maintained. The values of the series count S, the parallel count P, and the signal amplification strength T included in the second operator Q_{ph,T} are selected so as to satisfy the required estimation accuracy (computation conditions).

FIG. 5 shows a configuration of the second operator Q_{ph,T}(520). The second operator Q_{ph,T}(520) includes rotation gates 521, 522, 523, and a Grover operator Q(524) (controlled Grover operator CQ) as a control gate. The rotation gates 521, 522, 523 respectively perform a rotation of ζᵢ about the X-axis of the Bloch sphere, a rotation of π/2 about the Z-axis, and a rotation of −ζᵢ about the X-axis.

The second operator Q_{ph,T}(520) includes L instances of the controlled Grover operator CQ. Increasing L reduces the approximation error of the second operator Q_{ph,T}. A sufficiently large value of L is set such that the approximation error of the second operator Q_{ph,T} is sufficiently small relative to the required estimation error F for amplitude estimation. According to prior research on quantum signal processing by G. H. Low et al., this condition is satisfied by increasing L so that L scales as L=O(T+log(PS/ε)) with respect to ε, P, S, and T. From this relational expression, in order to reduce L when achieving amplification by a factor of M(=P S·T), it is preferable to increase the duration T of the time evolution rather than the series count S in the series direction. However, when T is relatively large, computation of the rotation angle ζ becomes more difficult. Accordingly, for example, T may be set to 1.

Next, the computation device 20 estimates the amplitude α from the approximate value of φ_{α}=2(1−2α) obtained by the above-described procedure (step S14). The computation device 20 then outputs the estimation result of the amplitude to the user terminal 10.

The present embodiment provides the following advantages.

In the present embodiment, the computation device 20 forms the Grover operator from the first operator Uₚᵣ (step S11) and, by quantum signal processing, forms a second operator Q_{ph,T}, which is compatible with the parallel strategy, from the controlled Grover operator formed from the Grover operator (Step S12). By using the second operator Q_{ph,T}, phase estimation employing the parallel strategy (step S13) can be performed. Further, the amplitude α can be estimated from the value of the estimated phase (step S14). By estimating the amplitude α using this procedure, the estimation accuracy may be improved by arranging multiple instances of the first operator Uₚᵣ not only in the series direction but also in the parallel direction. By arranging the first operator Uₚᵣ in the parallel direction, the depth is reduced compared with arranging the first operator Uₚᵣ in only the series direction, thereby improving scaling of the depth with respect to the estimation error ε. Thus, more efficient utilization of computational resources, reduced computation time, and reduction in the required coherence time Tc may be realized.

In this case, the scaling of the depth of the quantum circuit with respect to ε, and the scaling of the number N of invocations of the first operator Uₚᵣ (query complexity), are as follows. However, Sₘₐₓ and Tₘₐₓ denote the maximum values of S and T in the quantum circuit executed for the estimation.

$$Depth = O ( {S}_{max} ( 1 / {ε}^{*} + log ( {ε}^{*} / ε ) ) )$$

$$N = O ( \frac{{ε}^{*} log ( {ε}^{*} / ε ) + 1}{ε} )$$

$${ε}^{*} = 1 / {T}_{max}$$

When the first operator Uₚᵣ is arranged only in the parallel direction (i.e., when Sₘₐₓ and Tₘₐₓ are equal to 1), the depth scales as O(log(1/ε)), which is exponentially smaller than O(1/ε) of conventional techniques. Furthermore, the query complexity increases only to o(ε* log(ε*/ε)ε) compared with the query complexity of O(1/ε) of conventional techniques. Since this increase in query complexity is a logarithmic value with respect to the estimation error ε, thus may be essentially negligible. This result is due to the fact that the number L of the instances of the first operator Uₚᵣ required to form the second operator Q_{ph,T} is L=0(T+log(PS/ε)) with respect to the estimation error ε.

The above-described embodiment may be modified as follows. The above-described embodiment and the following modifications can be combined while the combined modifications remain technically consistent.

In the above-described embodiment, the Grover operator is formed from the first operator Uₚᵣ, and the second operator Q_{ph,T} is formed from the controlled Grover operator, which has been formed from the Grover operator, by applying quantum signal processing. However, as long as the first operator Uₚᵣ can be used to form the second operator Q_{ph,T} to which the parallel strategy can be applied, the procedure for converting the operator is not limited to this approach. When forming the second operator Q_{ph,T} by a method other than the one described in the embodiment above, the entangling operator may be an operator that prepares a quantum state in which the |0 [symbol] and |1 [symbol] of the GHZ state are replaced with two eigenstates to which the second operator Q_{ph,T} imparts a phase difference. In addition, when the second operator Q_{ph,T} is formed by a method other than the one described in the embodiment above, the value φₐ embedded into the phase of the quantum state by the second operator Q_{ph,T} may take a different expression from φ_{α}=2(1−2α), for example φ_{α}=α.

As another procedure for forming an operator to which the parallel strategy can be applied, quantum singular value transformation (QSVT) may be used. The first operator Uₚᵣ satisfies the following relational expression. The use of QSVT to transform 1−2α into e^{iTα} approximately forms an operator to which the parallel strategy can be applied. When forming the second operator Q_{ph,T} by this procedure, the computational cost is comparable to that incurred when using QSP as described in the above-described embodiment.

$${〈 0 {\vert}_{n + 1} {U}_{pr}^{†} {U}_{f} {U}_{pr} \vert 0 〉}_{n + 1} = 1 - 2 a$$

In the above-described embodiment, the estimation accuracy is ensured by the series count S, the parallel count P, and the signal amplification strength T included in the second operator Q_{ph,T}. When the parallel count P is sufficiently large, it is not necessary to increase the series count S or the signal amplification strength T included in the second operator Q_{ph,T}. When estimation accuracy cannot be ensured with the series count S, the parallel count P, and the signal amplification strength T included in the second operator Q_{ph,T}, computational resources may be increased based on a scaling of N=O(1/ε²). In this way, the series count S, the parallel count P, and the signal amplification strength T included in the second operator Q_{ph,T} can be flexibly set according to the required estimation accuracy.

In the above-described embodiment, estimation accuracy is used as the computation condition. However, the computation condition is not limited to estimation accuracy, and any constraint condition relating to the computation may be employed. For example, the time required for computation may be used as the computation condition.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A quantum computing system comprising one or more processors and memory storing executable instructions that, when executed by the one or more processors, cause the quantum computing system to at least:
modulate, by an operation unit of a quantum computation unit, a quantum state of a qubit;
maintain, by a state holding unit of the quantum computation unit, the quantum state;
observe, by a measurement unit of the quantum computation unit, the quantum state;
obtain, at the operation unit, a first operator for use in performing an operation of embedding a parameter into an amplitude of the quantum state;
form, at the operation unit, a second operator, using the first operator, for use in performing the operation of embedding the parameter in a phase of the quantum state;
apply, at the measurement unit, a plurality of instances of the second operator in parallel to an entangled input state of the qubit;
measure the quantum state after applying the plurality of instances of the second operator to the entangled input state to produce a measurement result;
estimate a value of the phase of the quantum state based on the measurement result; and
estimate, at a classical computation unit, the parameter based on the value of the phase of the quantum state as estimated.

2. The quantum computing system according to claim 1, wherein the instructions further cause the quantum computing system to:
form, by the operation unit, a Grover operator from the first operator,
form, by the operation unit, a controlled Grover operator from the Grover operator, and
use, at the operation unit, quantum signal processing to form the second operator from the controlled Grover operator.

3. The quantum computing system according to claim 1, wherein the instructions further cause the quantum computing system to determine, at the operation unit, a parallel count in accordance with a provided computation condition, the parallel count being a number of instances of parallel application of the second operator.

4. The quantum computing system according to claim 3, wherein the instructions further cause the quantum computing system to:
determine, at the operation unit, a series count and a signal amplification strength in accordance with the parallel count and the provided computation condition, the series count being a number of instances of series application of the second operator, and the signal amplification strength being included in the second operator.

5. The quantum computing system according to claim 1, wherein the instructions further cause the quantum computing system to:
determine, at the operation unit, at least one of a series count and a signal amplification strength, the series count being a number of instances of series application of the second operator, and the signal amplification strength being included in the second operator, and
when a provided computation condition is not satisfied given at least one of the series count and the signal amplification strength, determine a parallel count, the parallel count being a number of instances of parallel application of the second operator.

6. The quantum computing system according to claim 3, wherein the provided computation condition includes at least one of estimation accuracy and computation time.

7. A quantum computing method, comprising:
obtaining a first operator for use in performing an operation of embedding a parameter into an amplitude of a quantum state of a qubit;
forming a second operator, using the first operator, for use in performing an operation of embedding the parameter in a phase of the quantum state;
applying a plurality of instances of the second operator in parallel to an entangled input state of the qubit;
measuring the quantum state after applying the plurality of instances of the second operator to the entangled input state to produce a measurement result;
estimating a value of the phase based on the measurement result; and
estimating the parameter based on the value of the phase of the quantum state as estimated.

8. The quantum computing method according to claim 7, further comprising:
forming a Grover operator from the first operator;
forming a controlled Grover operator from the Grover operator; and
using quantum signal processing to form the second operator from the controlled Grover operator.

9. The quantum computing method according to claim 7, further comprising determining a parallel count in accordance with a provided computation condition, the parallel count being a number of instances of parallel application of the second operator.

10. The quantum computing method according to claim 9, further comprising:
determining a series count and a signal amplification strength in accordance with the parallel count and the provided computation condition, the series count being a number of instances of series application of the second operator, and the signal amplification strength being included in the second operator.

11. The quantum computing method according to claim 7, further comprising:
determining at least one of a series count and a signal amplification strength, the series count being a number of instances of series application of the second operator, and the signal amplification strength being included in the second operator; and
when a provided computation condition is not satisfied given at least one of the series count and the signal amplification strength, determining a parallel count, the parallel count being a number of instances of parallel application of the second operator.

12. The quantum computing method according to claim 9, wherein the provided computation condition includes at least one of estimation accuracy and computation time.

13. A non-transitory computer-readable medium storing instructions, wherein, when executed by circuitry, the instructions cause the circuitry to at least:
obtain a first operator for performing an operation of embedding a parameter into an amplitude of a quantum state of a qubit;
form a second operator, using the first operator, for performing an operation of embedding the parameter in a phase of the quantum state;
apply a plurality of instances of the second operator in parallel to an entangled input state of the qubit;
measure the quantum state after applying the plurality of instances of the second operator to the entangled input state to produce a measurement result;
estimate a value of the phase based on the measurement result; and
estimating the parameter based on the value of the phase of the quantum state as estimated.

14. The non-transitory computer-readable medium according to claim 13, wherein the instructions further cause the circuitry to:
form a Grover operator from the first operator;
form a controlled Grover operator from the Grover operator; and
use quantum signal processing to form the second operator from the controlled Grover operator.

15. The non-transitory computer-readable medium according to claim 13, wherein the instructions further cause the circuitry to determine a parallel count in accordance with a provided computation condition, the parallel count being a number of instances of parallel application of the second operator.

16. The non-transitory computer-readable medium according to claim 15, wherein the instructions further cause the circuitry to:
determine a series count and a signal amplification strength in accordance with the parallel count and the provided computation condition, the series count being a number of instances of series application of the second operator, and the signal amplification strength being included in the second operator.

17. The non-transitory computer-readable medium according to claim 13, wherein instructions further cause the circuitry to:
determine at least one of a series count and a signal amplification strength, the series count being a number of instances of series application of the second operator, and the signal amplification strength being included in the second operator; and
when a provided computation condition is not satisfied given at least one of the series count and the signal amplification strength, determining a parallel count, the parallel count being a number of instances of parallel application of the second operator.

18. The non-transitory computer-readable medium according to claim 15, wherein the provided computation condition includes at least one of estimation accuracy and computation time.
